(19) United States
(12) Patent Application Publication
(10) Pub. No.: US 2026/0332186 A1
(43) Pub. Date: Oct. 22, 2026

(54) TIME, FREQUENCY, AND SPATIAL DIVERSITY IN A WIRELESS MULTICHANNEL AUDIO SYSTEM (WMAS)

(71) Applicant: WAVES AUDIO LTD., Tel Aviv (IL)

(72) Inventors: Dan Wolberg, Moshav Yanuv (IL); Nir Tal, Haifa (IL); Gadi Sharazi, Ramat Gan (IL)

(21) Appl. No.: 19/103,562

(22) PCT Filed: Aug. 15, 2023
(86) PCT No.: PCT/IL2023/050862

§ 371 Date: Feb. 13, 2025

(30) Foreign Application Priority Data
Aug. 17, 2022 (GB) 2211975.4

(51) Int. Cl. H04B 1/48

(52) U.S. Cl. CPC H04B 1/48

(57) ABSTRACT

A system and method for use in a multidevice bidirectional communication system such as a wireless multichannel audio system (WMAS). The WMAS includes a base station and multiple wireless audio devices such as microphones, in ear monitors, etc. that can be used for live events, concerts, night clubs, churches, etc. The point to multipoint star topology system does not require a set of independent communication subsystems on both sides. The system includes two or more transceivers in the base station side but only a single transceiver in the devices which in combination with a novel protocol, provides the system with time, frequency and/or spatial diversity. This significantly reduces cost and form factor, while increasing the reliability and signal quality due to the extra redundancy and diversity in the system.

### FIELD OF THE DISCLOSURE

The subject matter disclosed herein relates to the field of communications and more particularly relates to systems and methods of time, frequency, and spatial diversity in a multidevice bidirectional communication system such a Wireless Multichannel Audio System (WMAS).

### BACKGROUND OF THE INVENTION

Wireless audio and video (A/V) equipment used for realtime production of audio-visual information such as for entertainment or live events and conferences are denoted by the term program making and special events (PMSE). Typically, the wireless A/V production equipment includes cameras, microphones, in-ear monitors (IEMs), conference systems, and mixing consoles. PMSE use cases can be diverse, while each commonly being used for a limited duration in a confined local geographical area. Typical live audio/video production setups require very low latency and very reliable transmissions to avoid failures and perceptible corruption of the media content.

Wireless microphones are in common use today in a variety of applications including large venue concerts and other events where use of wired microphones may not be practical or preferred. A wireless microphone has a small, battery-powered radio transmitter in the microphone body, which transmits the audio signal from the microphone by radio waves to a nearby receiver unit, which recovers the audio. Other audio equipment is connected to the receiver unit by cable. Wireless microphones are widely used in the entertainment industry, television broadcasting, and public speaking to allow public speakers, interviewers, performers, and entertainers to move about freely while using a microphone without requiring a cable attached to the microphone.

Wireless microphones usually use the VHF or UHF frequency bands since they allow the transmitter to use a small unobtrusive antenna. Inexpensive units use a fixed frequency but most units allow a choice of several frequency channels, in case of interference on a channel or to allow the use of multiple microphones at the same time. FM modulation is usually used, although some models use digital narrowband modulation to prevent unauthorized reception by scanner radio receivers; these operate in the VHF, UHF or 900 MHz, 2.4 GHz or 5-6 GHz ISM bands. Some models use antenna diversity (i.e. two antennas) to prevent nulls from interrupting transmission as the performer moves around. Most analog wireless microphone systems use wideband FM modulation or narrowband digital modulation, requiring approximately 200 kHz of bandwidth.

An important band for wireless transmission is the UHF band. The UHF band is used for many applications including TV stations (e.g., DVB, DVBT, LPAS, etc.). Most modern wireless microphone products operate in the UHF television band. In the United States, this band extends from 470 MHz to 614 MHz. Typically, wireless microphones operate on unused TV channels (‘white spaces’), with room for one to three microphones per megahertz of spectrum available. The UHF band is used for wireless microphone transmission under FCC under parts 74 and 15 for licensed and unlicensed systems, respectively, in vacant TV stations. Prior art narrowband implementations, however, require the user to plan a frequency map and determine frequencies of individual channels without causing harmful interference of one channel to the other and other spectrum users (i.e. TV stations). Some of the harmful RF effects that are evident in prior art solutions are inter-modulation products from two transmitting devices, reciprocal mixing from receiver or transmitter phase noise, etc. Furthermore, since the medium is noisy and may contain time dependent interference patterns (i.e., a channel can get corrupted in mid use), some narrowband systems employ a frequency diversity scheme. This scheme uses two or more frequencies/channels to provide redundancy and improved reliability for time dependent noise patterns.

Pure digital wireless microphone systems are also in use that use a variety of digital modulation schemes. Some use the same UHF frequencies used by analog FM systems for transmission of a digital signal at a fixed bit rate. These systems encode an RF carrier with one channel, or in some cases two channels, of digital audio. Advantages offered by purely digital systems include low noise, low distortion, the opportunity for encryption, and enhanced transmission reliability.

Some digital systems use frequency hopping spread spectrum technology, similar to that used for cordless phones and radio-controlled models. As this can require more bandwidth than a wideband FM signal, these microphones typically operate in the unlicensed 900 MHz, 2.4 GHz or 6 GHz bands.

Several disadvantages of wireless microphones include (1) limited range (a wired balanced XLR microphone can run up to 300 ft or 100 meters); (2) possible interference from other radio equipment or other radio microphones; (3) operation time is limited relative to battery life; it is shorter than a normal condenser microphone due to greater drain on batteries from transmitting circuitry; (4) noise or dead spots, especially in non-diversity systems; (5) limited number of operating microphones at the same time and place, due to the limited number of radio channels (i.e. frequencies); (6) lower sound quality.

Therefore, there is a need for a point to multipoint system that aggregates the channels per user, automatically allocates frequencies, and establishes a transmission regime that avoids the problems with existing technology. Furthermore, this system should be able to allocate two or more channels for use in a frequency diversity scheme and utilize them efficiently in a manner that improves system reliability without significantly increasing complexity, cost, or device form factor.

### SUMMARY OF THE INVENTION

This disclosure describes a system and method of time, frequency, and/or spatial diversity for use in a multidevice bidirectional communication system such as a wireless multichannel audio system (WMAS). The WMAS of the invention comprises a base station and a plurality of wireless audio devices such as microphones, in ear monitors, etc. that can be used for live events, concerts, night clubs, churches, etc. The WMAS is a multichannel digital wideband system as opposed to most commercially available narrowband (e.g., GFSK, π/4QPSK) analog prior art wireless microphone systems. The system may be designed to provide diversity in time, frequency, and/or space.

The present invention may provide a WMAS system that includes a base station and multiple wireless audio devices, which may comprise microphones, in ear monitors, etc. The network may include a point to multipoint wireless transmission system. It is noted that prior art diversity implementations require an independent communication subsystem for every diversity dimension (e.g., for frequency diversity of two, two independent communication subsystems are required on both sides of the channel). Thus, the RF transceiver, modem, and antenna must be duplicated. This type of redundancy significantly raises the total system cost and form factor.

The present invention may provide a point to multipoint star topology system which does not require a set of independent communication subsystems on both sides. Such a system includes a fully independent transceiver set on the base station side but fewer subsystems on the wireless audio device side since there are typically many devices in the network and only one base station.

The present invention may provide an architecture and a protocol, which enables WMAS point to multipoint operation with time, frequency and/or spatial diversity, while having only one transceiver in the wireless audio devices. This allows for a significantly reduced cost and form factor, while significantly increasing the reliability and signal quality due to the extra redundancy and diversity in the system.

In one embodiment, a system, protocol, and architecture are provided for 2-fold frequency diversity. In another embodiment, the system, protocol, and architecture for a 4-fold (i.e. 2 frequency×2 spatial) diversity is disclosed. In yet another embodiment, a 2-fold spatial diversity system, protocol, and architecture is disclosed.

This, additional, and/or other aspects and/or advantages of the embodiments of the present invention are set forth in the detailed description which follows; possibly inferable from the detailed description; and/or learnable by practice of the embodiments of the present invention.

There is thus provided in accordance with the invention, a system for providing diversity in a wireless multichannel audio system (WMAS), comprising a base station including a plurality of radio frequency (RF) transceivers, each having a transmitter and a receiver capable of tuning to a plurality of frequencies, a plurality of wireless audio devices, each wireless audio device including a single RF transceiver including a single RF transmitter tunable to said plurality of frequencies in accordance with a frequency control signal, and a single RF receiver tunable to said plurality of frequencies in accordance with said frequency control signal, a TX/RX switch operative to switch said single RF transceiver between transmission and reception modes, and wherein transmission and reception of said base station and said single RF transmitter and said single RF receiver in each said wireless audio device are controlled in accordance with a predefined protocol to provide time, frequency, and/or spatial diversity in said system.

There is also provided in accordance with the invention, a system for providing diversity in a wireless multichannel audio system (WMAS), comprising a base station including a first plurality of radio frequency (RF) transceivers capable of tuning to a plurality of frequencies and a second plurality of RF transceivers capable of tuning to said plurality of frequencies, wherein antennas associated with said first and second plurality of RF transceivers are located a sufficient distance apart from each other so that the channels are uncorrelated, a plurality of wireless audio devices, each wireless audio device including a single RF transceiver including a single RF transmitter tunable to said plurality of frequencies in accordance with a frequency control signal, and a single RF receiver tunable to said plurality of frequencies in accordance with said frequency control signal, a TX/RX switch operative to switch said single RF transceiver between transmission and reception modes, and wherein transmission and reception of said base station and said single RF transmitter and said single RF receiver in each said wireless audio device are controlled in accordance with a predefined protocol to provide time, frequency, and/or spatial diversity in said system.

There is further provided in accordance with the invention, a method of providing diversity in a wireless multichannel audio system (WMAS), the method comprises providing a base station having a plurality of radio frequency (RF) transceivers, each having a transmitter and a receiver capable of tuning to a plurality of frequencies, providing a plurality of wireless audio devices, each wireless audio device including a single RF transceiver including a single RF transmitter tunable to said plurality of frequencies in accordance with a frequency control signal, and a single RF receiver tunable to said plurality of frequencies in accordance with said frequency control signal, a TX/RX switch operative to switch said single RF transceiver between transmission and reception modes, and controlling said single RF transmitter in at least one wireless audio device to transmit on a first frequency selected from said plurality of frequencies, controlling said single RF receiver in at least one wireless audio device to receive on a second frequency selected from said plurality of frequencies, and switching said single RF transceiver in each wireless audio device between transmission and reception in accordance with a predefined protocol to provide time, frequency, and or spatial diversity in said system.

### BRIEF DESCRIPTION OF THE DRAWINGS

The present invention is explained in further detail in the following exemplary embodiments and with reference to the figures, where identical or similar elements may be partly indicated by the same or similar reference numerals, and the features of various exemplary embodiments being combinable. The invention is herein described, by way of example only, with reference to the accompanying drawings, wherein:

FIG. 1 is a diagram illustrating an example wireless multichannel audio system (WMAS) incorporating the system and method of clock synchronization of the present invention;

FIG. 2 is a high level block diagram illustrating an example device to base station uplink scheme;

FIG. 3 is a high level block diagram illustrating an example base station to device downlink scheme;

FIG. 4 is a diagram illustrating an example device/base station air interface unit;

FIG. 5 is a diagram illustrating an example base station 2-fold frequency diversity air interface unit;

FIG. 6 is a diagram illustrating an example base station 4-fold frequency and spatial diversity air interface unit;

FIG. 7 is a diagram illustrating an example air interface protocol for a 2-fold frequency diversity scheme;

FIGS. 8A and 8B are diagrams illustrating an example air interface protocol for a 4-fold frequency and spatial diversity scheme; and

FIG. 9 is a flow diagram illustrating an example switched diversity method for use in the wireless audio system.

### DETAILED DESCRIPTION

In the following detailed description, numerous specific details are set forth in order to provide a thorough understanding of the invention. It will be understood by those skilled in the art, however, that the present invention may be practiced without these specific details. In other instances, well-known methods, procedures, and components have not been described in detail so as not to obscure the present invention.

Among those benefits and improvements that have been disclosed, other objects and advantages of this invention will become apparent from the following description taken in conjunction with the accompanying figures. Detailed embodiments of the present invention are disclosed herein; however, it is to be understood that the disclosed embodiments are merely illustrative of the invention that may be embodied in various forms. In addition, each of the examples given in connection with the various embodiments of the invention which are intended to be illustrative, and not restrictive.

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings.

The figures constitute a part of this specification and include illustrative embodiments of the present invention and illustrate various objects and features thereof. Further, the figures are not necessarily to scale, some features may be exaggerated to show details of particular components. In addition, any measurements, specifications and the like shown in the figures are intended to be illustrative, and not restrictive. Therefore, specific structural and functional details disclosed herein are not to be interpreted as limiting, but merely as a representative basis for teaching one skilled in the art to variously employ the present invention. Further, where considered appropriate, reference numerals may be repeated among the figures to indicate corresponding or analogous elements.

Because the illustrated embodiments of the present invention may for the most part, be implemented using electronic components and circuits known to those skilled in the art, details will not be explained in any greater extent than that considered necessary, for the understanding and appreciation of the underlying concepts of the present invention and in order not to obfuscate or distract from the teachings of the present invention.

Any reference in the specification to a method should be applied mutatis mutandis to a system capable of executing the method. Any reference in the specification to a system should be applied mutatis mutandis to a method that may be executed by the system.

Throughout the specification and claims, the following terms take the meanings explicitly associated herein, unless the context clearly dictates otherwise. The phrases “in one embodiment,” “in an example embodiment,” and “in some embodiments” as used herein do not necessarily refer to the same embodiment(s), though it may. Furthermore, the phrases “in another embodiment,” “in an alternative embodiment,” and “in some other embodiments” as used herein do not necessarily refer to a different embodiment, although it may. Thus, as described below, various embodiments of the invention may be readily combined, without departing from the scope or spirit of the invention.

In addition, as used herein, the term “or” is an inclusive “or” operator, and is equivalent to the term “and/or,” unless the context clearly dictates otherwise. The term “based on” is not exclusive and allows for being based on additional factors not described unless the context clearly dictates otherwise. In addition, throughout the specification, the meaning of “a,” “an,” and “the” include plural references. The meaning of “in” includes “in” and “on.”

As will be appreciated by one skilled in the art, the present invention may be embodied as a system, method, computer program product or any combination thereof. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product embodied in any tangible medium of expression having computer usable program code embodied in the medium.

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented or supported by computer program instructions. These computer program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

The invention may be operational with numerous general purpose or special purpose computing system environments or configurations. Examples of well-known computing systems, environments, and/or configurations that may be suitable for use with the invention include, but are not limited to, personal computers, server computers, cloud computing, hand-held or laptop devices, multiprocessor systems, microprocessor, microcontroller or microcomputer based systems, set top boxes, programmable consumer electronics, ASIC or FPGA core, DSP core, network PCs, minicomputers, mainframe computers, distributed computing environments that include any of the above systems or devices, and the like.

### System Architecture

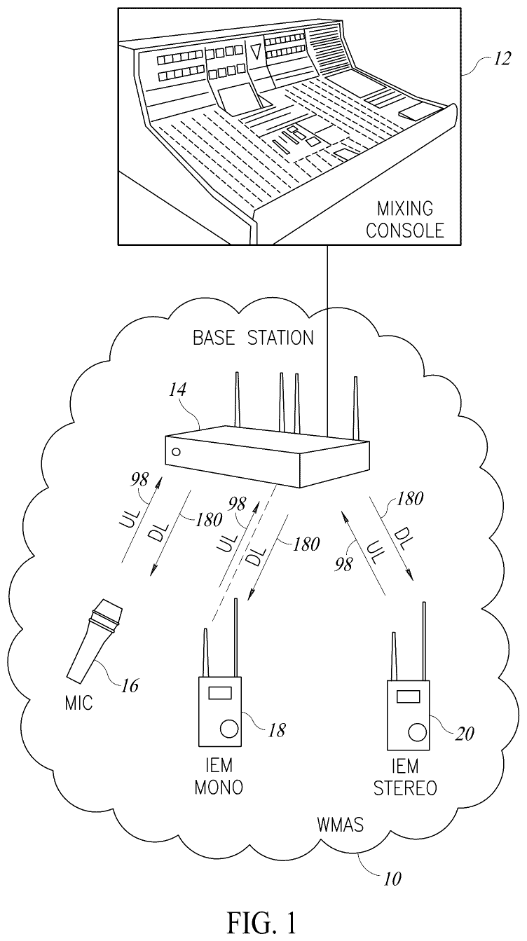

A diagram illustrating an example wireless multichannel audio system (WMAS) incorporating the system and method of clock synchronization of the present invention is shown in FIG. 1. The example WMAS, generally referenced 10, comprises a base station 14 which is typically coupled to a mixing console 12 via one or more cables, and a plurality of wireless devices including wireless microphones 16, monophonic in ear monitors (IEMs) 18, and stereo IEMs 20.

Wireless microphone devices 16 include an uplink (UL) 98 that transmits audio and management information and a downlink (DL) 180 that receives management information. IEM devices 18 include an uplink 98 that transmits management information and a downlink 180 that receives mono audio and management information. IEM devices 20 include an uplink 98 that transmits IMU and management information and a downlink 180 that receives stereo audio and management information.

WMAS 10 comprises a star topology network with a central base station unit (BS) 14 that communicates and controls all the devices within the WMAS (also referred to as “network”). The network is aimed to provide highly reliable low latency communication during a phase of a live event referred to as “Show Time”. The network at show time is set, and secured in a chosen configuration thereby minimizing overhead, typically present in existing wireless standards.

In one embodiment, the features of the WMAS include (1) star topology; (2) point to multipoint audio with predictable schedule including both downlink and uplink audio on the same channel (typically on a TVB frequency); (3) all devices time synchronized to base station frames; (4) support for fixed and defined devices; (5) support for frequency division multiplexing (FDM) for extended diversity schemes; (6) TDM network where each device transmits its packet based on an a priori schedule; (7) wideband base station with one or two transceivers receiving and transmitting many (e.g., greater than four) audio channels; (8) TDM/OFDM for audio transmissions and Wideband OFDM or OFDMA in downlink and a packet for each device in uplink; (10) main and auxiliary wireless channels are supported by all network entities; and (11) all over the air (OTA) audio streams are compressed with ‘zero’ latency.

In one embodiment, the WMAS system of the present invention achieves performance having (1) low packet error rate (PER) (e.g., 5×10⁻⁸) where retransmissions are not applicable because of low latency; (2) a short time interval of missing audio due to consecutive packet loss and filled by an audio concealment algorithm (e.g., 15 ms); and (3) acceptable range which is supported under realistic scenarios including body shadowing.

In addition, in one embodiment, the WMAS system is adapted to operate on the DTV white space UHF channels (i.e. channels 38-51). Note that the system may use a white space channel that is adjacent an extremely high-power DTV station channel while still complying with performance and latency requirements.

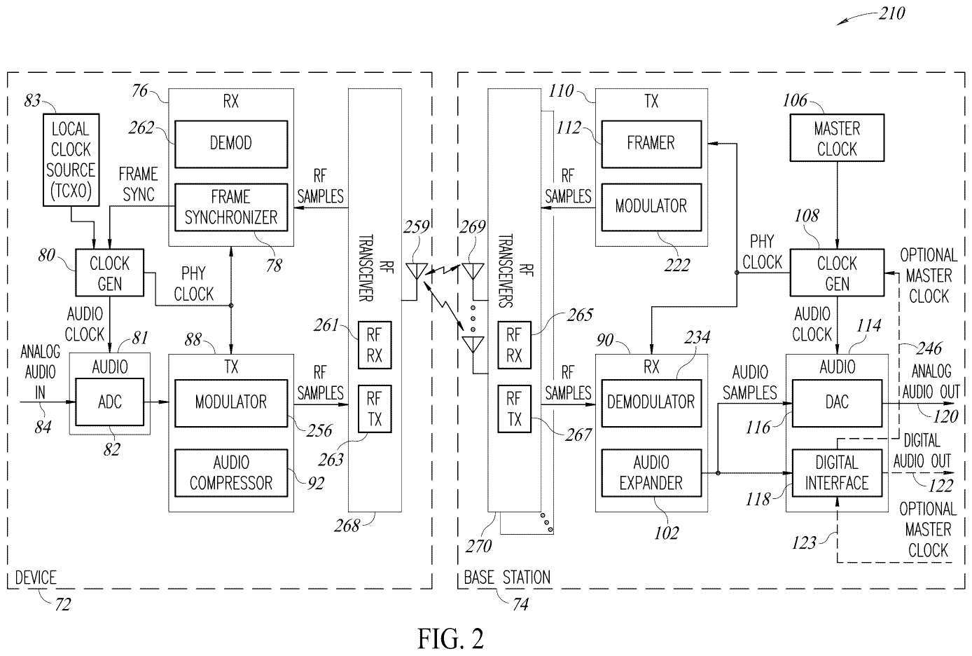

A high-level block diagram illustrating an example device to base station uplink scheme is shown in FIG. 2. The system, generally referenced 210, comprises base station 74 in communication with one or more wireless devices 72. e.g. microphone 16, in-ear monitor 18,20 over a radio link that make up the WMAS. The base station 74 comprises, inter alia, a master clock 106, clock generation circuit 108, multiple RF transceivers module 270, TX circuit 110, RX circuit 90, and audio circuit block 114. Each RF transceiver in module 270 comprises an RF transmitter 267 and RF receiver 265 and each transceiver is coupled to its own corresponding antenna 269. Note that transceiver module 270 in the BS may contain more than one RF receiver 265 and/or more than one RF transmitter 267 each transceiver coupled to its own antenna 269. The audio circuit 114 comprises DAC 116 that may generate an analog audio out signal 120. Audio circuit 114 may include a digital interface circuit 118 that may receive an optional external master clock signal 123 and generate an optional output master clock signal 246 to the clock generator circuit 108 and may also generate a digital audio out signal 122. The TX circuit 110 comprises framer 112 and modulator 222 to generate RF samples carrying clock information output to the RF circuit TX 267 for transmission to device 72. The RX circuit 90 comprises demodulator 234 and audio expander 102 and receives uplink RF samples from the RF RX 265 circuit to generate audio samples output to DAC 116.

The wireless audio device 72 comprises RF transceiver circuit 268, TX circuit 88, RX circuit 76, audio circuit block 81, local clock source (e.g., TCXO) 83, and clock generation circuit 80. RF transceiver 268 comprises an RF transmitter 263 and RF receiver 261 and is coupled to antenna 259. Audio circuit 81 comprises ADC 82. TX circuit 88 comprises modulator 256 and audio compressor 92. RX circuit 76 comprises demodulator 262 and frame synchronizer 78.

ADC 82 functions to convert analog audio input signal 84 to digital samples which are input to TX circuit 88. The RF samples output of TX circuit 88 are input to the RF circuit 268 for uplink transmission. On the receive side, RF receiver 261 outputs received RF samples carrying clock information to the RX circuit 76 where they are demodulated by demodulator 262. The frame synchronizer 78 generates timing from the received frames to synchronize its clocks with the base station master clock 106. The derived timing is input to the clock generator circuit 80 and is used to generate the various clocks in the device including the audio clock.

With reference to FIG. 2, the clock generator circuit 108 generates the required clocks including for example TX circuit 110, RX circuit 90, and audio clocks. TX circuit 110 includes a framer 112 and a modulator 222, while the RX circuit 90 includes a demodulator 234 and an audio expander 102. The audio expander 102 outputs digital samples after the expander process to either the DAC 116 in the audio system 114 or a digital interface 118. The base station also includes an RF circuit 270 which converts RF samples from the TX into RF waves and receives RF waves to output RF samples to the RX.

Uplink device 72 (e.g. wireless microphone, IEM, etc.), shown on the left hand side includes the receiver RX 76, a transmitter TX 88, an audio sub system 81 and a clock generator module 80. It is noted that in one embodiment uplink devices have two-way communications for management and synchronization purposes.

Clock gen module 80 functions to generate the clocks (e.g., PHY clock, audio clock, etc.) for the RX module 76, TX module 256, RF circuit 268, and audio systems 81 by locking and deriving digital clocks from the frame synchronization in the RX module 76. RX module 76 includes a demodulator 262 and a frame synchronizer 78, which locks onto the frame rate and phase using techniques such as packet detection, correlators, PLLs, DLLs, FLLs, etc.

TX module 88 includes a modulator 256, and an audio compressor and the audio contains an ADC 82 converting the input analog signals into digital audio samples. Furthermore, the device 72 contains an RF subsystem 268 which is operative to convert RF samples from the TX 88 into RF waves and receives RF waves to output RF samples to the RX 76.

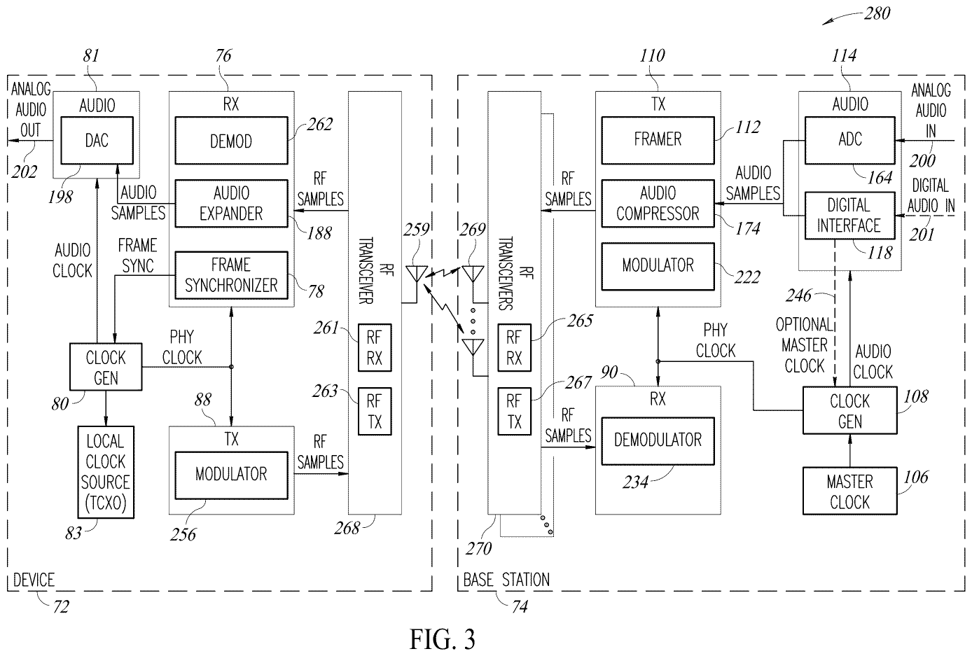

A high level block diagram illustrating an example base station 74 to device 72 downlink scheme is shown in FIG. 3. The system, generally referenced 280, comprises base station 74 in communication with one or more devices 72 over a radio link that make up WMAS 10. The base station 74 comprises, inter alia, a master clock 106, clock generation circuit 108, RF transceivers module 270, TX circuit 110, RX circuit 90, and audio circuit block 114. Each RF transceiver of module 270 including RF transmitter 267 and RF receiver 265 is coupled to a corresponding antenna 269. Note that transceiver module 270 in the base station may contain more than one RF receiver 265 and/or more than one RF transmitter 267, each transceiver module 270 is coupled to antenna 269. The audio circuit comprises ADC 164 that converts analog audio input signal 200 to digital audio samples and a digital interface 118. The digital interface circuit 118 may receive an optional digital audio input signal 201 from a mixing console 12 and generates output audio samples and an optional master clock 246 to the clock gen circuit 108. The TX circuit 110 comprises framer 112, audio compressor 174, and modulator 222 to receive the audio samples and generate RF samples output to the RF TX 267 for transmission. The RX circuit 90 comprises demodulator 234 that receives RF samples from the RF circuit to generate audio samples output to the DAC 116 (not shown in FIG. 3).

The device 72 comprises RF transceiver circuit 268, TX circuit 88, RX circuit 76, audio circuit block 81, local clock source (e.g., TCXO) 83, and clock generation circuit 80. RF transceiver 268, comprising an RF transmitter 263 and RF receiver 261, is coupled to antenna 259. Audio circuit 81 comprises DAC 198. TX circuit 88 comprises modulator 256 and audio compressor (not shown). RX circuit 76 comprises demodulator 262, audio expander 188, and frame synchronizer 78.

The RF samples output of the TX circuit 88 are input to the RF circuit 268 for transmission. On the receive side, the RF receive circuit 261 outputs received RF samples to the RX circuit 76 where they are demodulated. The frame synchronizer generates timing (frame sync signal) from the received frames to synchronize its clocks with the base station master clock. The derived timing is input to the clock gen circuit 80 and used to generate the various clocks in the device including the audio clock.

The system shown in FIG. 3 highlights the clocking scheme for the base station 74 and a downlink device 72 (e.g. microphone, IEM, etc.) in accordance with the present invention. Master clock 106 in base station 74 is used to derive and synchronize digital clocks within the entire system 10. This clock may comprise a local clock source such as an oscillator (e.g., TCXO, etc.) in base station 74 or optionally can be generated by the digital interface 118 from an input digital audio signal 201 from mixing console 12.

The clock generator circuit 108 generates the required clocks including for example TX, RX, RF, and audio clocks. The TX circuit 110 includes a framer 112, audio compressor 174, and a modulator 222, while the RX circuit 90 includes a demodulator 234. Analog audio in 200 is converted by the ADC 164 to digital audio samples. Base station 74 also includes an RF unit 270 which converts RF samples from the TX 267 into RF waves and receives RF waves to output RF samples to the RX 265.

The device (e.g., IEM, etc.) 72, shown on the left hand side includes the RF circuit 268, receiver RX 76, a transmitter TX 88, an audio sub system 81 and a clock generator module 80. It is noted that in one embodiment downlink devices have two-way communications for management and synchronization purposes.

The RX module 76 includes a demodulator 262 and a frame synchronizer 78, which locks onto the frame rate and phase using techniques such as packet detection, correlators, PLLs, DLLs, FLLs, etc. The clock gen module 80 functions to generate the clocks (e.g., PHY clock, audio clock, etc.) for the RX 76, TX 88, RF 268 circuits, and audio systems by locking and deriving digital clocks from the frame synchronization in the RX module 76. The RX includes a demodulator 262 and a frame synchronizer 78, which locks onto the frame rate and phase using techniques such as packet detection, correlators, PLLs, DLLs, FLLs, etc.

The audio circuit 81 contains a DAC 198 that converts the audio samples output of the audio expander to analog audio out 202. Furthermore, the TX 88 includes a modulator 256. An RF subsystem 268 is operative to convert RF samples from the TX 88 into RF waves and receives RF waves to output RF samples to the RX 261.

### RF Subsystems in the Base Station and Wireless Audio Devices

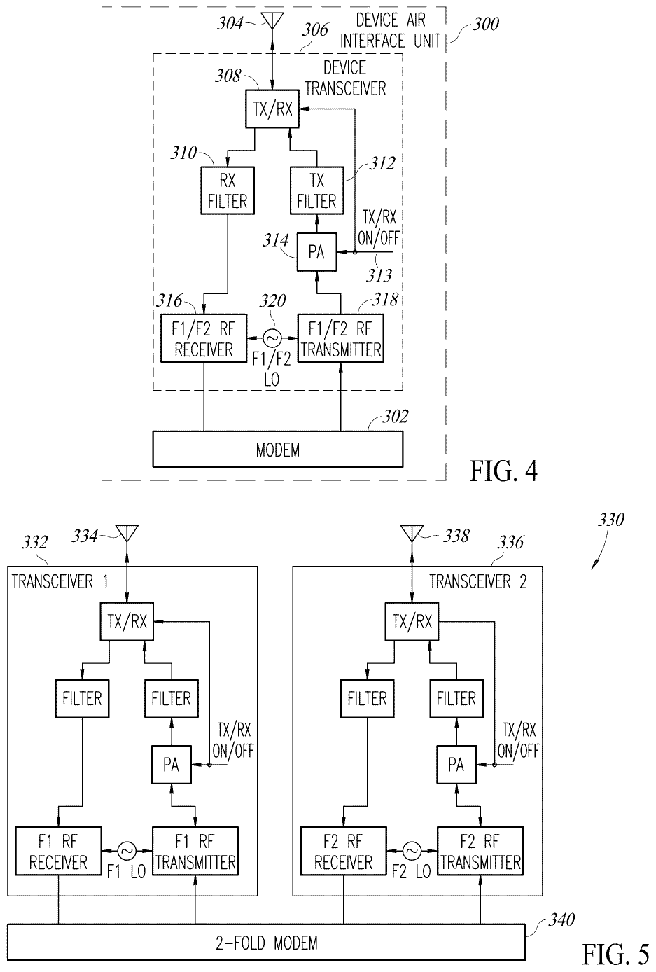

A diagram illustrating an example device air interface unit is shown in FIG. 4. The air interface unit, generally referenced 300, comprises a transceiver 306 coupled to RF antenna 304 and modem 302. Transceiver 306 may be used in the wireless audio devices 72 for transmission and reception. Transceiver 306 comprises a local oscillator (LO) 320 capable of tuning a subset of a plurality of frequencies (F1 and F2 in this example), an RF receiver 316 capable of tuning to a subset (F1 or F2) of frequencies F1 and F2, in this example. Transceiver 306 further includes RX filter 310, TX/RX switch 308, an RF transmitter 318 also capable of tuning to a subset (F1 or F2) of frequencies F1 and F2 in this example, power amplifier (PA) circuit 314, and TX filter 312. Antenna 304 is used for both reception and transmission. TX/RX switch 308 functions to select between transmission and reception in accordance with a provided TX/RX on/off control signal 313 so that the transceiver unit 306 selectably either transmits or receives during the same time slot in accordance with an air interface protocol. The frequency of transmission or reception is selected from multiple previously determined frequencies by selecting a local oscillator LO or clock 320. Note that the LO 320 may be located within the RF transceiver or external to it depending on the implementation.

The RF transmission path includes a power amplifier 314, which amplifies RF signals to wireless transmission levels during time slots when transmission is on, determined by TX/RX on/off control input 313. The transmit path is from the transmitter 318 through the TX filter 312 and TX/RX switch 308 to the RF antenna 304. The receive path is from the RF antenna 304 through TX/RX 308 switch during time slots when reception is on, and through RX filter 310 and to the receiver 316.

In accordance with the invention, each wireless audio device 72 comprises a single RF transceiver. Thus, to achieve time, frequency, and/or spatial diversity, minimal additional or redundant circuitry is required in the device compared to a device without any diversity capability. This reduces the cost and form factors significantly.

Time diversity is herein defined as transmitting the same message signal at a different time period, interval or slot to avoid fading and disturbance in the signal. Frequency diversity is defined herein as transmitting the same message signal at different carrier frequencies. Spatial diversity is defined herein as sending or receiving redundant streams of information in parallel along multiple spatial paths, thus increasing reliability and range since it is unlikely that all paths will be degraded simultaneously.

In operation, the device may receive or transmit at any given instance on one of multiple previously determined frequencies (F1 and F2 in the example shown here) based on the air interface protocol. To switch frequencies, the local oscillator 320 may be configured to switch or hop frequency which causes the RF receiver or transmitter to receive or transmit on a different previously determined frequency, respectively. An example frequency switching scheme that may be used is described in more detail infra.

In an alternative embodiment, the base station 74 simultaneously transmits over two frequencies, and the device 72 selects the channel with the best performance. In another alternative embodiment, the device 72 transmits two versions of the same information on multiple time slots at multiple frequencies and the base station 74 may receive multiple versions and select the best or combine them to achieve performance gains using one of several techniques well-known in the art.

### 2-Fold Frequency Diversity Base Station Topology

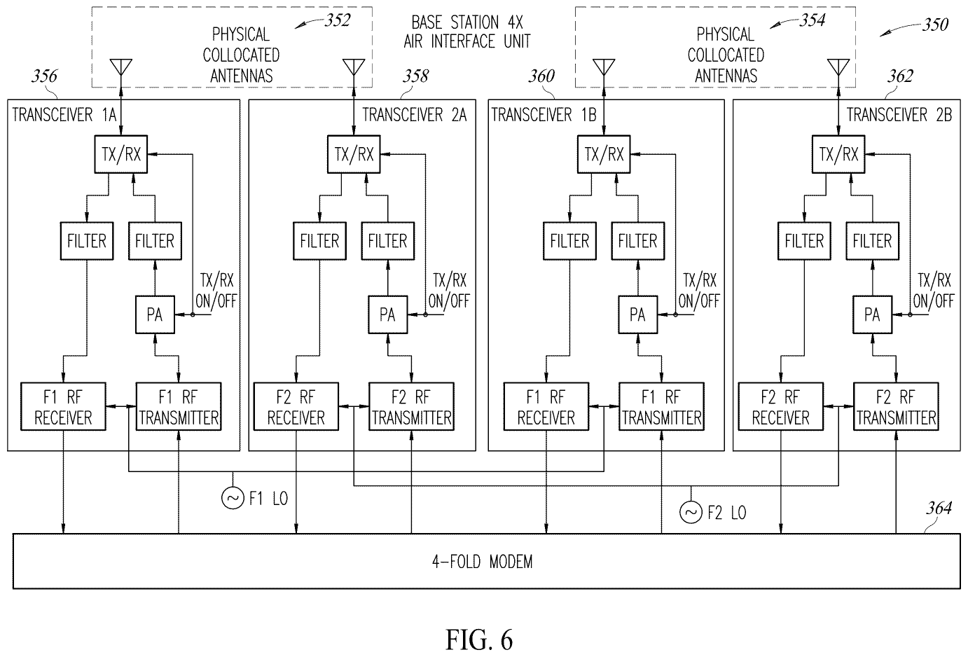

A diagram illustrating an example base station 2-fold frequency diversity air interface unit is shown in FIG. 5. The air interface, generally referenced 330, comprises a 2-fold modem 340, adapted to receive RF samples and convert them into audio data and vice versa in two frequencies simultaneously, two RF transceivers, namely RF transceiver 1 332 and RF transceiver 2 336 each connected to an RF antenna 334, and 338, respectively. The architecture of each transceiver 332, 336 is similar to that of transceiver 306 (FIG. 4) described supra. One difference is that each transceiver 332, 336 may comprise a single set of local oscillators adapted to receive or transmit from only one channel or RF frequency (frequency F1 in transceiver 332 and frequency F2 in transceiver 336) rather than selecting among a set of frequencies as in transceiver 306. Each transceiver 332, 336 may comprise one RF receiver and one RF transmitter. Similar to transceiver 306, the RF section includes a power amplifier which amplifies RF signals to wireless transmission levels, a transmit filter, a receiver filter and a TX/RX switch (transmit/receive switch) which chooses the correct path based on the air interface protocol.

The base station air interface 330 allows the base station 74 to transmit independent data on two or more frequencies, e.g., (F1 and F2 simultaneously and receive independent data on two frequencies F1 and F2 simultaneously. In this implementation, there is one independent transceiver per diversity dimension (e.g., two transceivers for 2-fold frequency diversity). It is appreciated that one skilled in the art may construct a higher dimension frequency diversity circuit (e.g., 3-fold, 4-fold, etc.) using a similar technique.

### 2-Fold Spatial Diversity Base Station Topology

In an alternative embodiment, the system 330 of FIG. 5 may be adapted to a 2-fold spatial diversity architecture by tuning both sets of local oscillators to the same frequency (F1 or F2) or sharing one set of local oscillators tuned to either F1 or F2 between the two transceivers 332, 336. In this case the RF transceivers are similar to those of FIGS. 4 and 5 but the two antennas 334, 338 (FIG. 5) are located a sufficient distance apart from each other to create spatial diversity; so that the channels are uncorrelated, typically specified as being at least for example 1.7λ, 5λ, 10λ, in different embodiments etc. where λ is the wavelength of the RF frequency in a vacuum in use by the system. In one embodiment, for example, the antennas 334, 338 are located least a minimum of 10λ where λ is the RF wavelength in use by the system in a vacuum.

This architecture allows the base station to transmit using a Space Time Block Code (STBC) such as an Alamouti code in the downlink to achieve a theoretical improvement of 3 dB in the Signal to Noise Ratio (SNR). In the uplink, this architecture allows for two receivers tuned on the same frequency to receive two correlated signals with sufficiently uncorrelated noise and obtain an improved SNR using Maximum Ratio Combining (MRC).

### 4-Fold Frequency Diversity Base Station Topology

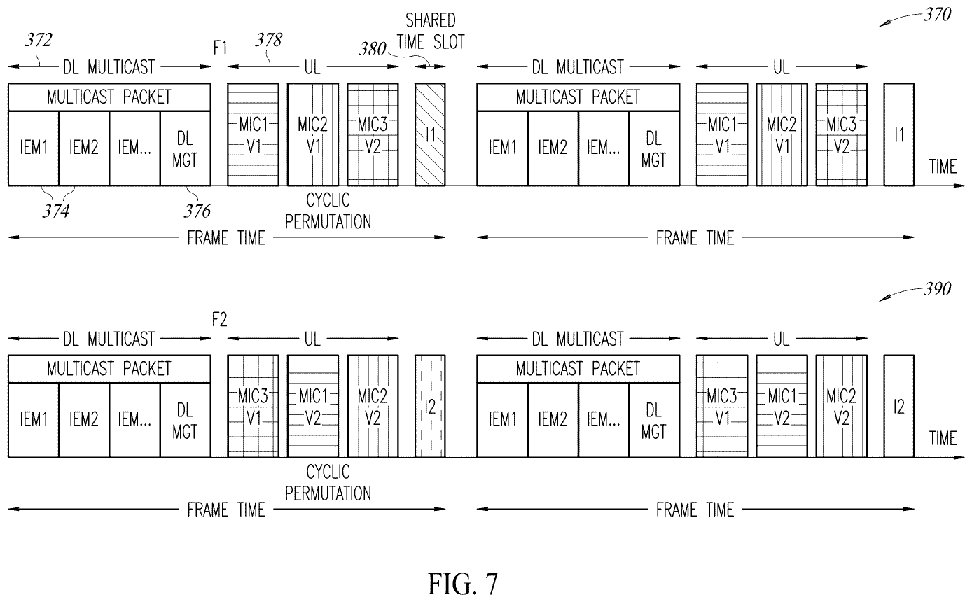

A diagram illustrating an example base station 4-fold frequency and spatial diversity (i.e. combined 2-fold frequency diversity and 2-fold spatial diversity) air interface unit is shown in FIG. 6. The architecture, generally referenced 350, comprises four RF transceiver units 356, 358, 360, 362 coupled to 4-fold modem 364. Two of the RF transceivers are configured to receive or transmit on one frequency F1 labeled transceivers 1A 356 and 1B 360, respectively, and another two are configured to receive or transmit on another frequency F2 labeled transceivers 2A 358 and 2B 362, respectively. There are two sets of local oscillators in this embodiment, one adapted to receive or transmit on frequency F1 and the other adapted to receive or transmit on frequency F2.

In one embodiment, the antennas 352 connected to transceivers 1A 356 and 2A 358 are collocated meaning they are in close physical proximity to each other, e.g., in the same antenna enclosure, etc. The antennas 354 connected to transceivers 1B 360 and 2B 362 are also collocated, preferably at a sufficient distance from the location of the first antennas 352 where the channels are uncorrelated. This means that the antennas from transceivers 1A and 1B and the antennas from transceivers 2A and 2B are separated by a sufficient distance between them so that the channels are uncorrelated, typically specified as being at least for example 1.7λ, 5λ, 10λ, in different embodiments, where λ is the wavelength of RF frequency in a vacuum in use by the system.

4-Fold frequency diversity allows the system 350 to transmit or receive simultaneously four independent signals on two spatially independent streams. The streams may be combined such that two correlated symbols or signals are transmitted on each frequency, i.e. employing a Space Time Block Code (STBC), thereby improving the received signal-to-noise ratio (SNR) by recombination in a single fold receiver. This can be achieved, for example, by transmitting an Alamouti code from two antennas on the same frequency.

In a receive mode of operation, the two transceiver antennas receiving on the same frequency (either 1A 356, 1B 360 or 2A 356, 2B 362) may provide two spatially correlated signals with sufficiently uncorrelated noise and combined to generate a signal having a superior signal to noise ratio (SNR) using, for example using maximal ratio combining (MRC). Note that in this example embodiment, four transceivers are used for a 4-fold diversity scheme (2-fold frequency diversity and 2-fold space diversity) but additional transceivers may be deployed to provide higher order diversity schemes.

### 2-Fold Frequency Diversity Air Interface Protocol

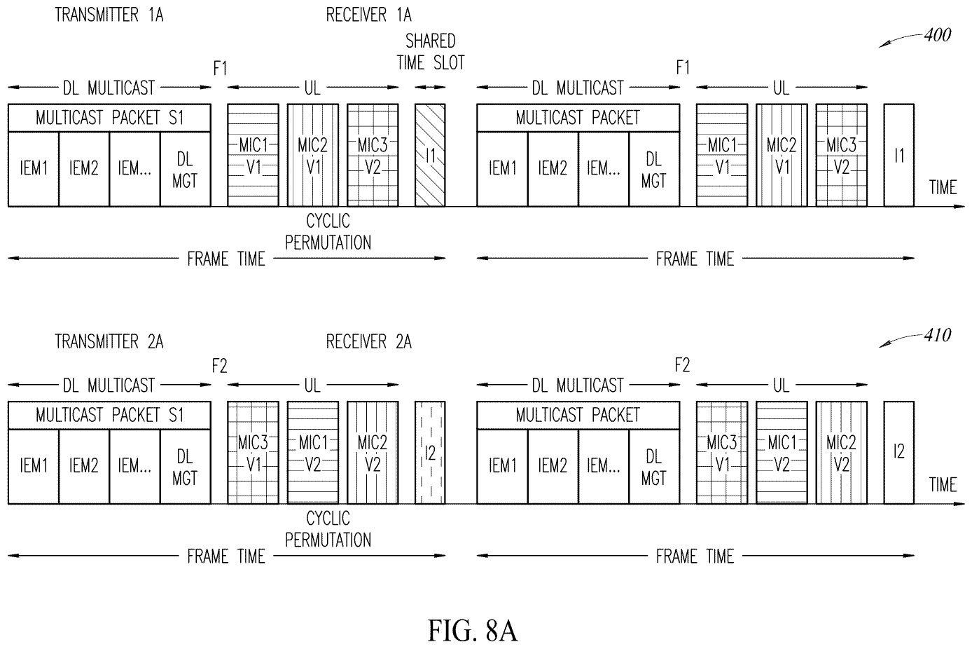

In order to achieve diversity (i.e. time, frequency, and/or spatial) using a single RF transceiver in the wireless audio devices 72, the system as described in various embodiments 210, 280, 300, 330, 350 supra (FIGS. 2-6) may be operated according to a novel protocol that is now described below. The protocol effectively utilizes resources in the devices 72 and base station 74 is such a way to significantly improve reliability of the connections between the entities 72, 74 in the network with no significant cost added to the devices 72. A timeline diagram illustrating an example air interface protocol for a 2-fold frequency diversity scheme is shown in FIG. 7. The frame structure for two consecutive frames transmitted on each frequency F1, F2 are shown. The rectangles depict packets transmitted by the base station 74 or one of the wireless audio devices 72 of the WMAS 10 (FIG. 1).

The transmission time slots are determined by the protocol and are normally regular from frame to frame. Frame structures that are transmitted simultaneously on frequencies F1 and F2 are shown each having identical and synchronous frame structure 370 and 390, respectively. In one embodiment, the frame duration may be regular, e.g., 2 milliseconds. The frame packet timing may be identical on each frequency and is adapted to allow sufficient quiet times in order for RF transients to settle down and local oscillators in the transceivers to switch when necessary.

Each frame, generally referenced 370 or 390, comprises a downlink multicast packet 372 from the base station 74 to all devices 72 that includes downlink data 374 destined to individual devices 72 on the network 10 such as in ear monitors (IEMs 18,20) as well as downlink management data 376 for all devices. Each frame also comprises several uplink packets 378 from several devices 72 such as microphones 16 to the base station 74. In addition, a shared time slot 380 includes data from any entity 72, 74 in the network 10 that is broadcast to the base station 74 or to all other entities in accordance with a known schedule.

Note that subsequent frames on the same frequency F1 include uplink data packets transmitted in the same order frame after frame. Frames 390 transmitted on the other frequency F2, however, include uplink packets from devices 72 in the network 10 that are transmitted in a non-simultaneous sequence, hence no device 72 transmits on two frequencies simultaneously. This sequence is repeated in subsequent frames on the same frequency F2. The sequence is adapted such that two devices 72 never transmit an uplink packet on two frequencies at the same time. This may be achieved for instance by using a cyclic permutation between the transmission sequence on F1 and F2, for example. Thus, if the sequence on frequency F1 is Mic1, Mic2, Mic3 then the sequence on frequency F2 may be Mic3, Mic1, Mic2.

It is appreciated that the air interface may employ any suitable digital modulation such as Orthogonal Frequency Division Multiplexing (OFDM), Orthogonal Frequency Division Multiplexing Access (OFDMA), Single Carrier Quadrature Amplitude Modulation (SC-QAM), etc.

In one embodiment, the frame structure comprises three distinct portions: (1) a downlink multicast packet 372 transmitted simultaneously on frequencies F1 and F2, (2) an uplink time division multiplexed (TDM) packets 378 transmitted by the devices 72, and (3) a management queue time slot I1, I2 380 shared by multiple or all network entities (i.e. wireless audio devices and the base station). Note that the data transmitted may comprise plain text or encrypted text using algorithms such as the Advanced Encryption Standard (AES) and may be coded using a Forward Error Correction (FEC) code such as a Convolutional Code or a Block Code. Different packets may include different versions (i.e. different bits)/algorithms of encryption and coding.

### Downlink Multicast:

In one embodiment, the first part of the frame is dedicated to a single multicast packet 372 originating from the base station 74 to all wireless audio devices 72 and includes data destined for each device 72. The data (e.g., compressed audio) is multiplexed within the multicast packet in accordance with the modulation scheme used. For example, in OFDM, a certain OFDM symbol may be dedicated to a certain device. Further, in OFDMA a certain carrier/bin/resource unit may be allocated to a certain device. Typically, the downlink multicast packet may contain a training sequence or symbols at the beginning, transmitted to each of the devices to allow the devices to synchronize. Optionally, downlink management messages from the base station 74 to the devices 72 may be multiplexed shown as time slot downlink management (DL MGT) 376 within the downlink multicast packet as with the audio data transmitted to the devices.

Note that in the 2-fold frequency diversity protocol shown in FIG. 7 the same management message and data may be transmitted on both frequencies F1 and F2 allowing the device receiver to operate a switched diversity scheme. In this case, the downlink multicast packet structure may be identical for each frame on the two frequencies.

### Uplink TDM:

In the uplink TDM section, each device 72 transmits a packet in a designated time slot. The packet includes uplink data (e.g., compressed audio) as well as a training sequence allowing the base station 74 to synchronize. Each device 72 transmits two versions of the packet, which may or may not be identical, on two different time slots on the two frequencies F1 and F2. The protocol may permute the time slots using a cyclic permutation or otherwise scramble the time slots to configure the device not to transmit on two frequencies F1 and F2 at the same time.

This protocol thus allows the wireless audio devices to each have a single transmitter, configured to transmit in different time slots on the two different frequencies F1 and F2. In addition, the base station has two receivers configured to receive on frequencies F1 and F2 simultaneously. In one embodiment, the base station is configured to receive two versions of the same uplink data packet from each device which enables a performance enhancing algorithm to combine then providing switched diversity, etc. based on the two versions. Note also that the uplink TDM packet structure and timing may be identical for each frame.

### Management Queue TDM Time Slot I1, I2

Notwithstanding the DL MGT time slot 376 in the downlink multicast packet 372, each frame also includes a management queue TDM time slot where each network entity (i.e. wireless audio device and base station) transmits slow management data during times slots labeled I1, I2 380 in the frame structure. In one embodiment, each network entity is allocated a certain position in the queue and transmits its data on a given frequency in a given frame number.

For example, Table 1 presented below shows an example scheduling system for a two microphone (MIC), two in ear monitor (IEM) system. The table shows a repeating pattern of five frames where in each one a given network entity is transmitting on F1 and another network entity transmits on F2. Each network entity has exactly one transmission in F1 and one transmission in F2.

TABLE 1
Management Queue TDM Time Slot Example Schedule

| Frame Number | Frequency F1 | Frequency F2 |
|---|---|---|
| 1 | MIC1 | IEM1 |
| 2 | MIC2 | IEM2 |
| 3 | IEM1 | MIC2 |
| 4 | IEM2 | MIC1 |
| 5 | BS | BS |
| . . . | . . . | . . . |

Note that the management queue time slots I1, I2 may be used as a back channel to transmit telemetry, e.g., received signal strength indication (RSSI), battery indication, etc. The base station management packets may contain null packets used by the devices to monitor the channel quality and determine the switched diversity position F1 or F2 in subsequent frames.

### Switched Diversity on Device Receive (RX)

Since each wireless audio device has only one RF receiver, the device is able to receive the downlink multicast packet in one frequency at any given time/frame. The device, however, may decide based on a number of factors, on which frequency (F1 or F2) to receive in order to maximize successful reception.

In one embodiment, each wireless audio device track one or more statistics on the alternative channel by decoding both the downlink multicast packet as well as the base station 74 null management packet on the alternate frequency. The statistics tracked may include, e.g., packet error rate (PER), cyclic redundancy check (CRC) errors, RSSI, error vector magnitude EVM, etc. For example, the device 72 may receive the downlink multicast packet on F1 and may listen to the base station null management packet on F2 or vice versa.

A frequency switch between the two frequencies for the main downlink packet may be brought about by:
(1) The device 72 compares the long-term statistics to short term statistics. If there is a significant difference it can indicate an impending degradation. A more accurate mathematical criterion may include updating a Bayesian probability of a short-term statistic given the longer-term statistic and comparing the updated Bayesian probability to a threshold.
(2) Measuring packet loss statistics where consecutive packet losses above a certain threshold, e.g., three consecutive packet losses, indicate a frequency switch.
(3) A flip of the highest received signal strength indicator (RSSI) or better error vector magnitude (EVM) channel may also indicate a frequency switch.

It is appreciated that the mechanisms described supra on which a frequency switch between F1 and F2 may be based are sufficiently sensitive and the frequency switching performed sufficiently fast so that the user does not notice a degradation in system performance.

### Uplink TDM Full Diversity

Reference is again made to FIG. 6, an embodiment of the present invention in which the base station 74 comprises paired receivers, each tuned to a different frequency F1 and F2. The base station receives on both frequencies (i.e., F1 and F2) simultaneously and receives two different packets from two wireless audio devices simultaneously. In addition, BS receives two versions of each packet from each device in two different time instances on the two frequencies F1, F2. Having received two versions of the same packet, the base station may decide which version to output to the upper layers (e.g., for playing audio) based on e.g., a correctly decoded (CRC based) packet. This means that in the worst case, the base station 74 will need to decode both packets and output only the correctly decoded packet.

### 4-Fold Frequency and Spatial Diversity Air Interface Protocol

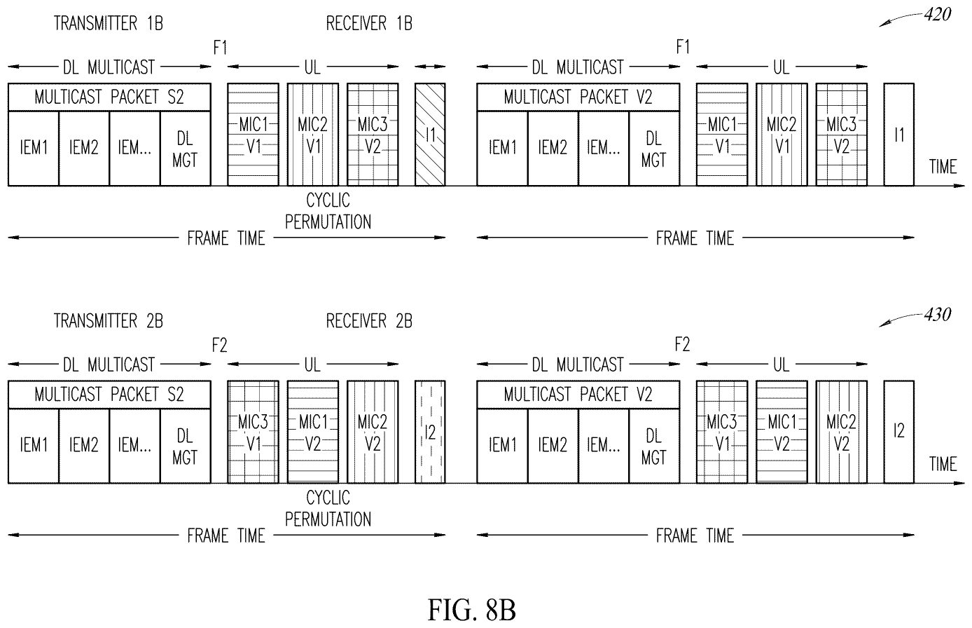

Reference is now also made to FIGS. 8A and 8B, illustrating a timeline diagram for example an air interface protocol for a 4-fold frequency and spatial diversity scheme as shown for example in FIG. 6. The timeline diagram is shown with rectangles each depicting a packet transmitted by a network entity (i.e., base station or one of the wireless audio devices). The overlaid frames show which transmitter or receiver element in the base station transmits or receives the packets respectively.

With reference FIGS. 6. 8A and 8B, the base station comprises four full RF transceivers with two transceivers 1A, 1B (356, 360) receiving or transmitting at F1 and two transceivers 2A, 2B (358, 362) receiving or transmitting at F2. In one embodiment, transmitters 1A and 2A are physically collocated 352 (e.g., part of the same antenna assembly). Transmitters 1B and 2B are also physically collocated 354 where each group of physically collocated antennas 352, 354 are separated by a distance, depending on embodiment, larger than 1.7λ, 5λ, 10λ, where λ is the RF wavelength in use in a vacuum.

Packet structures for the four transceivers are shown in FIGS. 8A and 8B, namely frame structure 400, 410, 420, 430 corresponding to transceivers 1A, 2A, 1B, 2B, respectively. In each frame, the transmitters in the respective transceivers 1A, 2A in the base station transmit an S1 downlink multicast packet on frequencies F1 and F2. Receivers 1A and 2A receive uplink packets from the devices in scrambled non-overlapping sequence such that no device transmits on two frequencies at the same time. Note that S1 and S2 signify the simultaneous symbols as generated by the STBC algorithm. For example, in the Alamouti STBC, S1 and S2 are determined by:

$$( \begin{matrix}S 1 \\ S 2\end{matrix} ) = \{ \begin{matrix}( \begin{matrix}{c}_{1} \\ - {c}_{2}^{*}\end{matrix} ) & even symbols \\ ( \begin{matrix}{c}_{2} \\ {c}_{1}^{*}\end{matrix} ) & odd symbols\end{matrix} \qquad ( 1 )$$

where:
   c₁, c₂ are OFDM symbols
   x* denotes the complex conjugate of x
   S₁, S₂ denote the symbols transmitted on F1 and F2, respectively

For the downlink packets, there are four transmitters in operation (i.e. transmitters 1A, 1B, 2A, and 2B). For the uplink packets (i.e. all uplink packets transmitted from one device transmitter at any given time), there are four receivers in the base station (i.e. receivers 1A, 1B, 2A, and 2B).

Note that the packets may employ any suitable digital modulation such as Orthogonal Frequency Division Multiplexing (OFDM), Orthogonal Frequency Division Multiplexing Access (OFDMA), Single Carrier Quadrature Amplitude Modulation (SC-QAM), etc.

In one embodiment, the transmission slot times and locations are determined by the protocol and repeat at regular frame intervals (e.g., 2 ms intervals). Note that the frame packet timing is identical on each frequency and is configured to allow the system sufficient quiet times for RF transients to settle down and local oscillators to switch where necessary.

### Downlink Multicast Message

In the 4-fold diversity configuration, there are two transmitters transmitting on each frequency, which are physically separated from each other. The system improves the reliability and signal quality by introducing coding gain in a Space Time Block Code (STBC). For example, the system may transmit an Alamouti code from the two spaced apart antennas on any frequency, which allows for a 3 dB coding gain due to spatial diversity. The code also improves the reliability significantly in case the path between one of the transmitting antennas and the receiving antenna is blocked by a physical medium (e.g., body shadowing which is common during performances). In this case, the system becomes a Single Input Multiple Output system (SIMO).

Note that during normal operation, the wireless audio device receivers still have a choice of switched diversity between the two frequencies F1, F2, on which the same information is transmitted.

In addition, the device is operative to track one or more statistics (e.g., PER, CRC errors, RSSI, EVM, etc.) on the alternative channel by decoding both the downlink multicast packet as well as the base station null management packet on the alternate frequency. For example, the device may receive the downlink multicast packet on F1 and listen to the base station null management packet on F2 or vice versa.

As described supra, a frequency switch between the two frequencies for the main downlink packet may be brought about by:
(1) The device compares the long-term statistics to short term statistics. If there is a significant difference it can indicate an impending degradation. A more accurate mathematical criterion may include updating a Bayesian probability of a short-term statistic given the longer term statistic and comparing the updated Bayesian probability to a threshold.
(2) Measuring packet loss statistics where consecutive packet losses above a certain threshold, e.g., three consecutive packet losses, indicate a frequency switch.
(3) A flip of the highest RSSI or better EVM channel may also indicate a frequency switch.

### Uplink TDM 4-Fold Diversity

In this mode, the base station has two sets of physically collocated spatially separated antennas and receivers per frequency. In this case, each uplink transmission is received in two versions. Twice on the same frequency for the first version on spatial diverse antennas and twice for the second frequency for the second version on spatial diverse antennas.

The base station receiver may combine a single transmitted version from two spatially separated antennas by employing well-known techniques such as maximum ratio combining (MRC) which combines the signals received over the air based on the SNR ratio in the case of identical versions, and switched diversity which selects the packet with the correct CRC in the case of non-identical versions, etc.

The two transmitted versions on the two different frequencies provide an extra layer of redundancy and diversity. For example, if one frequency is completely blocked by an interferer or by extreme fading, the receivers on the other frequency may be able to pick up the packet and decode it without any loss.

### 2-Fold Spatial Diversity

In an alternative embodiment, when only two antennas are available in the base station, the 4-fold frequency and spatial diversity system described supra can be downscaled to a 2-fold space diversity system. This is especially useful when the frequency resources are scarce. In the downlink, the two physically separated transmitters on the same frequency may transmit an STBC, whereas in the uplink the two receivers will receive one version of the uplink packets and may employ MRC or switched diversity.

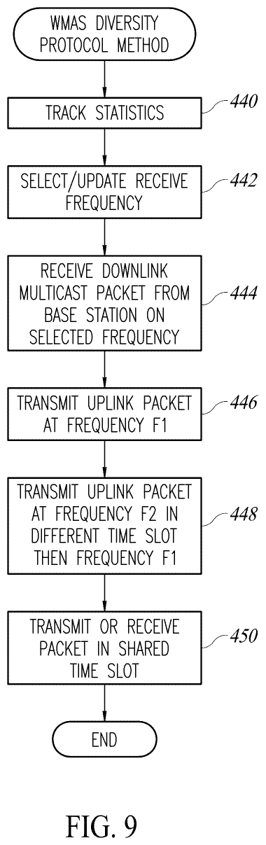

A flow diagram illustrating an example switched diversity method for use in the wireless audio system is shown in FIG. 9. In one embodiment, the wireless audio devices and/or the base station periodically or continuously track one or more reception statistics (step 440). The statistics measured are used to select or update an optimum frequency to receive on (step 442). Once a frequency is selected, the local oscillator in the transceiver is configured appropriately to the selected frequency. The downlink multicast packet from the base station is received on the selected frequency (step 444). The device then transmits an uplink packet at frequency F1 during its scheduled time slot (step 446). The uplink packet is also transmitted at an alternative frequency F2 in a time slot that does not overlap with the frequency F1 time slot (step 448). One of the network entities (either a wireless audio device or the base station) then transmits a packet in a shared time slot that is broadcast to all entities (step 450).

The term “frequency control signal” as used herein is an internally generated control signal used to select a local frequency of transmission and/or reception in the network entity, either base station 74 or wireless devices 72 responsive to management signaling as disclosed herein between base station 74 and wireless devices 72.

In an alternative embodiment, beam forming on each frequency may be combined with any of the embodiments discussed supra which replaces the STBC. In this embodiment, the base station (downlink) transmitter transmits multiple correlated spatial streams derived from a single stream using Channel State Information (CSI) derived from previously received packets from multiple wireless audio devices. Since the downlink packet is multicast, the transmitter derives such coefficients that improve the SNR at the wireless audio devices with the worst channels. Although this might slightly degrade the better performing wireless audio device receivers it improves the overall network reliability. This technique is known as joint multicast beamforming.

The term “synchronous” as used herein refers to continuous and consistent timed transfer of data blocks. Synchronous data transmission is a data transfer method in which a continuous stream of data signals is accompanied by timing signals (generated by an electronic clock) to ensure that the transmitter and the receiver are in step (synchronized) with one another. The data is sent in blocks, i.e. frames or packets spaced by fixed time intervals. The term “packet” as used herein refers to a portion of a frame.

Those skilled in the art will recognize that the boundaries between logic and circuit blocks are merely illustrative and that alternative embodiments may merge logic blocks or circuit elements or impose an alternate decomposition of functionality upon various logic blocks or circuit elements. Thus, it is to be understood that the architectures depicted herein are merely exemplary, and that in fact many other architectures may be implemented which achieve the same functionality.

Any arrangement of components to achieve the same functionality is effectively “associated” such that the desired functionality is achieved. Hence, any two components herein combined to achieve a particular functionality may be seen as “associated with” each other such that the desired functionality is achieved, irrespective of architectures or intermediary components. Likewise, any two components so associated can also be viewed as being “operably connected,” or “operably coupled,” to each other to achieve the desired functionality.

Furthermore, those skilled in the art will recognize that boundaries between the above-described operations merely illustrative. The multiple operations may be combined into a single operation, a single operation may be distributed in additional operations and operations may be executed at least partially overlapping in time. Moreover, alternative embodiments may include multiple instances of a particular operation, and the order of operations may be altered in various other embodiments.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

In the claims, any reference signs placed between parentheses shall not be construed as limiting the claim. The use of introductory phrases such as “at least one” and “one or more” in the claims should not be construed to imply that the introduction of another claim element by the indefinite articles “a” or “an” limits any particular claim containing such introduced claim element to inventions containing only one such element, even when the same claim includes the introductory phrases “one or more” or “at least one” and indefinite articles such as “a” or “an.” The same holds true for the use of definite articles. Unless stated otherwise, terms such as “first,” “second,” etc. are used to arbitrarily distinguish between the elements such terms describe. Thus, these terms are not necessarily intended to indicate temporal or other prioritization of such elements. The mere fact that certain measures are recited in mutually different claims does not indicate that a combination of these measures cannot be used to advantage.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description but is not intended to be exhaustive or limited to the invention in the form disclosed. As numerous modifications and changes will readily occur to those skilled in the art, it is intended that the invention is not limited to the limited number of embodiments described herein.

All optional and preferred features and modifications of the described embodiments and dependent claims are usable in all aspects of the invention taught herein. Furthermore, the individual features of the dependent claims, as well as all optional and preferred features and modifications of the described embodiments are combinable and interchangeable with one another.

The embodiments were chosen and described in order to best explain the principles of the invention and the practical application, and to enable others of ordinary skill in the art to understand the invention for various embodiments with various modifications as are suited to the particular use contemplated.

1. A wireless multichannel audio system (WMAS), comprising:
a base station including a plurality of radio frequency (RF) transceivers, each having a transmitter and a receiver capable of tuning to a plurality of frequencies;
a plurality of wireless audio devices configured for synchronous communication with the base station of modulated audio signals, each wireless audio device including:
a single RF transceiver including a single RF transmitter tunable to an uplink transmission RF frequency in accordance with a frequency control signal, and a single RF receiver tunable to a downlink reception RF frequency in accordance with said frequency control signal; and
a transmit/receive switch input operative to switch said single RF transceiver between transmission and reception modes;
wherein the wireless audio devices include a plurality of microphones and a plurality of in-ear monitors,
wherein the base station is configured to transmit audio data to the in-ear monitors respectively in distinct time slots in synchronous frames,
wherein the base station is configured to receive RF modulated data containing audio information from the microphones in time slots of synchronous frames,
wherein two of the microphones are configured to transmit in the same time slot on different frequencies.

2. (canceled)

3. The system of claim 1, wherein at least one wireless audio device dynamically determines a frequency for reception of downlink multicast packets.

4. The system of claim 1, wherein the wireless audio devices are configured to transmit time division multiplex (TDM) uplink packets to said base station on different frequencies in synchronous frames.

5. The system of claim 1, wherein at least one of the wireless audio devices is configured to transmit to the base station at least two versions of a same TDM uplink packet on different frequencies and in different time slots.

6. The system of claim 1, wherein the base station is configured to broadcast to the wireless audio devices a management packet in a previously defined time slot in synchronous frames.

7. The system of claim 1, wherein at least one wireless audio device is configured to monitor statistics of received frequencies to determine an optimal frequency for reception.

8. (canceled)

9. The system of claim 1, wherein the base station includes a first pair and a second pair of said RF transceivers, the first pair of RF transceivers each having a transmitter and a receiver capable of tuning to a first frequency and the second pair of RF transceivers each having a transmitter and a receiver capable of tuning to a second frequency, wherein said first frequency and said second frequency are different.

10. The system of claim 1, wherein the RF transceivers in said base station comprise at least two RF receivers tuned to the same frequency and adapted to perform maximum ratio combining (MRC), the base station further comprising:
antenna ports associated with said at least two RF receivers, wherein spatial diversity is provided when antennas, respectively connectable to the antenna ports, are interspaced a minimum of 1.7% from each other, wherein λ is an RF wavelength in use by the system.

11. The system of claim 1, wherein the RF transceivers in said base station comprise at least two RF transmitters tuned to the same frequency and adapted to transmit spatially diverse streams using Space Time Block Code (STBC), the base station further comprising antenna ports associated with said at least two RF transmitters, wherein spatial diversity is provided when antennas respectively connectable to the antenna ports are interspaced a minimum of 1.7λ from each other, wherein λ is an RF wavelength in use by the system.

12. The system of claim 1, wherein each wireless audio device and/or said base station is configured to transmit modulated data according to at least one of Orthogonal Frequency Division Multiplexing (OFDM), Orthogonal Frequency Division Multiple Access (OFDMA) packets, and Single Carrier Quadrature Amplitude Modulation (SC-QAM).

13. The system of claim 1, wherein said base station is operative to perform beam forming at least one frequency.

14. The system of claim 1, wherein the base station RF transceivers are capable of tuning to frequencies selected from previously determined local clock frequencies, wherein the uplink transmission RF frequency and the downlink reception RF frequency are selected from previously determined local clock frequencies.

15. A method of providing diversity in a wireless multichannel audio system (WMAS), the method comprising:
providing a base station having a plurality of radio frequency (RF) transceivers, each having a transmitter and a receiver capable of tuning to a plurality of frequencies;
providing a plurality of wireless audio devices configured for synchronous communication with the base station including modulated audio signals, each wireless audio device including: a single RF transceiver including a single RF transmitter tunable to said frequencies in accordance with a frequency control signal, and a single RF receiver tunable to said frequencies in accordance with said frequency control signal, and a transmit/receive switch operative to switch said single RF transceiver between transmission and reception modes;
controlling said single RF transmitter in at least one wireless audio device to transmit on a frequency selected from said frequencies;
controlling said single RF receiver in at least one wireless audio device to receive on a frequency selected from said frequencies; and
switching said single RF transceiver in each wireless audio device between transmission and reception; wherein the wireless devices include a plurality of microphones and a plurality of in-ear monitors;
allocating a first RF frequency and a second RF frequency;
synchronously transmitting from the base station respectively in distinct time slots to the in-ear monitors at both the first RF frequency and the second RF frequency; and
receiving at the base station respectively in synchronous time slots RF modulated data containing audio information from the microphones, wherein any two of the microphones are configured to transmit in the same time slot on different RF frequencies.

16-18. (canceled)

19. The method of claim 15, further comprising enabling transmission by at least one of the wireless audio devices to the base station at least two versions of a same TDM uplink packet on different frequencies and in different time slots.

20. The method of claim 15, further comprising: enabling broadcast of a management packet in a previously defined time slot in synchronous frames.

21. (canceled)

22. The method of claim 2115, further comprising:
monitoring statistics by at least one wireless audio device of frequencies transmitted from the base station, thereby determining an optimal frequency for reception;
receiving from said base station on the determined frequency, a downlink multicast packet by at least one wireless audio device from said base station

23. The method according to claim 15, wherein said base station includes antenna ports associated with the RF transceivers, the method further comprising spacing apart at least two antennas connectable to the antenna ports are interspaced a minimum of 1.7λ from each other, wherein λ is an RF wavelength in use by the system, thereby providing spatial diversity.

24. The method according to claim 15, further comprising receiving at said base station at least two versions of an uplink transmission from a single wireless audio device on different RF receiver frequencies, thereby providing frequency diversity.

25-26. (canceled)

27. A wireless audio device in a wireless multichannel audio system (WMAS) including a base station, the wireless audio device comprising a single RF transceiver operative to communicate synchronously with the base station modulated audio signals, the wireless audio device including:
a single RF transmitter tunable to a plurality of frequencies in accordance with a frequency control signal;
a single RF receiver tunable to said frequencies in accordance with said frequency control signal; and
a transmit/receive switch operative to switch said single RF transceiver between transmission and reception modes,
wherein the wireless audio device is configured to operate either as a microphone or an in-ear monitor,
wherein the base station is configured to transmit audio data to the in-ear monitor respectively in a distinct time slot in synchronous frames,
wherein the base station is configured to receive RF modulated data containing audio information from the microphone in a time slot of synchronous frames,
wherein two of microphones are configured to transmit in the same time slot on different frequencies.

28. A base station configured for use in a wireless multichannel audio system (WMAS) including a plurality of wireless audio devices, the base station comprising:
a plurality of radio frequency (RF) transceivers, each having a transmitter and a receiver capable of tuning to a plurality of frequencies, each transmitter operative to transmit a downlink multicast packet on one of said frequencies to said wireless audio devices, and wherein the base station is configured to receive by at least two said receivers, at least two versions of a same time division multiplex (TDM) uplink packet on different frequencies and in different time slots,
wherein the wireless audio devices include a plurality of microphones and a plurality of in-ear monitors,
wherein the base station is configured to transmit audio data to the in-ear monitors respectively in distinct time slots in synchronous frames, and
wherein the base station is configured to receive RF modulated data containing audio information from the microphones in time slots of synchronous frames, wherein the audio information in the same time slot from two microphones are received on different frequencies.
